(19) United States
(12) Patent Application Publication
(10) Pub. No.: US 2003/0089213 A1
(43) Pub. Date: May 15, 2003

(54) Knife

(76) Inventors: Anders Frick, Iggesund (SE); Mats Engnell, Iggesund (SE)

Correspondence Address: FITZPATRICK CELLA HARPER & SCINTO, 30 ROCKEFELLER PLAZA, NEW YORK, NY, 10112, US

(21) Appl. No.: 10/330,266

(22) Filed: Dec. 30, 2002

Related U.S. Application Data
(62) Division of application No. 08/765,267, filed on Dec. 20, 1996.

(30) Foreign Application Priority Data
Jun. 29, 1994 (SE) 9402310-8

(51) Int. Cl. B26D 5/08

(52) U.S. Cl. 83/592

(57) ABSTRACT

A knife for disk type chip cutter machines with a circular rotatable cutter disk (10) on its first axial side being provided with several knives running from the disk centre to its periphery. An opening (14) is provided in the disk in connection with each knife. The opening (14) has a chip guiding surface to guide separated chips to the other axial cutter disk side. The knife includes a knife carrier, on which the knife Is fixed between a first carrier part (18) provided essentially in line with the first axial cutter disk surface and second carrier part (16) extending downwards in the opening from said cutter disk surface into the cutter disk inside and being a part of the chip guiding device. The knife (12) is on its side facing the other carrier part provided with a chip breaking surface (22) passing the other carrier part (16) into the opening and protecting said carrier part from wear in that the separated chips by means of the chip breaking surface are guided in a direction away from the carrier part.

The present invention relates to a knife for disk type chip cutter machines with a circular rotatable cutter disk on its first axial side being provided with several knifes running from the disk centre to its periphery and an opening being provided in the disk in connection with each knife, the opening having a chip guiding surface to guide separated chips to the other axial cutter disk side, the knife comprising a knife carrier, on which the knife is fixed between a first carrier part provided essentially in line with the first axial cutter disk surface and second carrier part extending downwards in the opening from said cutter disk surface into the cutter disk inside and being a part of the chip guiding device.

In such knives with the knife fixed between two parts, one of which even serves as a chip guide through the opening in the cutter disk, a fast and heavy wear occurs of said last mentioned part, when the chips are hitting the part and even, when hard impurities accompanying the chips are hitting the part.

Several attempts have been made to solve this problem by means of exchangeable wear plates provided at the carrier part as part of the chip guide. All so far known devices, however, involve an increased cost level during manufacturing and during an exchange of worn parts.

The main objective of the present invention is to provide a knife, where the problems of the guiding surface wear is solved in a simple and economical way.

This and other objectives of the invention are achieved by providing it with the characteristics specified in the claims which follow.

The invention will be described hereinafter more in detail in connection with an execution example shown in the drawing, where

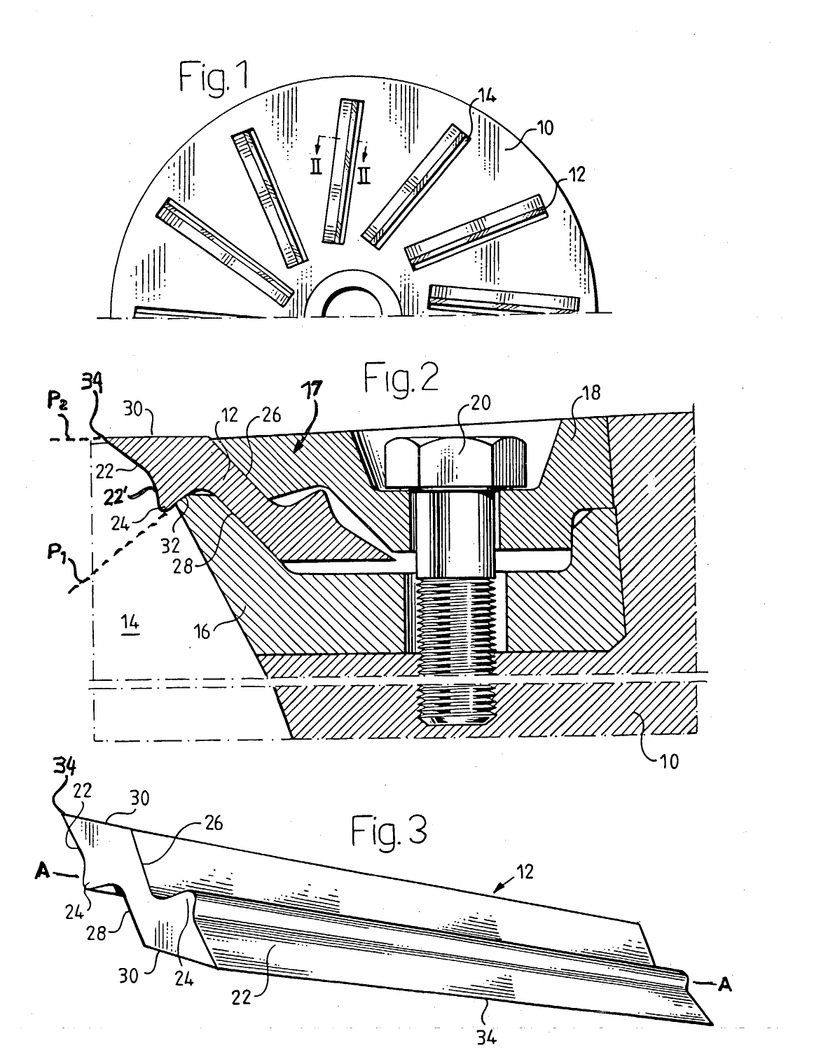

FIG. 1 shows a plane view of a part of a cutter disk with inserted knives,

FIG. 2 shows a section through a knife according to the invention along line II-II in FIG. 1, and

FIG. 3 is a perspective view of the knife of the invention.

In FIG. 1 a part of a cutter disk 10 is shown, mounted on which are several knives 12 extending from the disks 10 centre towards its circumference. Connected with each knife are provided openings 14, through which the cut chips are passing from the disks 10 one axial surface to its opposite surface.

In FIG. 2 the knife according to the invention is shown in section illustrating the fixing of the knife 12 in a cartridge arranged in a recess in the cutter disk 10. The cartridge consists of a carrier part 16 and a fixing part 18 keeping the knife fixed between them by means of a bolt 20 passing through openings in the cartridge parts 16 and 18, respectively. Normally, the lower carrier part 16 of the cartridge provides also the chip guide and is thus exposed to heavy wear resulting in an exchange with relatively small intervals. This part 16 due to its function as a fixing part having a special form requiring a machining during manufacturing is relatively expensive and the need to change this part within small intervals increases the service costs for the cutter.

According to the invention another way is envisaged to solve the described problem. The knife 12 being preferably reversible is of course exposed to a heavy wear and is thus reversed and exchanged, respectively, to be reground or changed. To minimize the chip chocks against the lower carrier part and the wear of it the knife 12 according to the invention is provided with a chip breaking surface 22 guiding the cut chips in a direction away from the carrier part 16 and from the cutter disks 10 underlying surface. For example, the chip breaking surface 22 is provided, in that the knife 12 is formed with a rib or a protrusion 24 passing the carrier part 16 with the knife 12 in a fixed position in the cartridge, so that the chips or splinters definitely receive a motion direction leading away from the carrier part 16 and the cutter disk 10.

As shown in FIG. 2 the knife 12 has two parallel plane contact surfaces 26, 28 in contact with corresponding surfaces on the carrier part 16 and the fixing part 18 to fix the knife into the cartridge. The knife edge is provided by a plane surface 30 essentially coinciding with the cutter disks' 10 axial surface, and the previously described chip breaking surface 22—in the execution example here shown first running straight and thereafter changing into a slightly concave shape to provide the guide surface for the chips or splinters. The chip breaking surface 22 is by means of the rib 24 connected to a plane surface 32 supported by a corresponding surface of the carrier part 16 providing a support for the knife 12 when under load. The knife 12 is as mentioned reversible in that it is symmetric around an axis parallel to the knife edges and situated centrally inbetween these, the knife then being identically uniform after a reversion half a turn around said axis.

By providing a chip breaking surface 22 according to the invention on the knife 12 itself large savings are made in the service costs, in that the cartridge carrier part 16 and the cutter disk 10 to a great extent are protected against wear. The wear thus occurs on the knife surface 22, this being of minor importance, as the knife 12 in any case has to be reversed or changed, when the edge becomes dull.

Evidently the embodiment shown and described above is only one example of the implementation of the invention and this can be changed and modified within the scope of the claims which follow.

1. A knife for disk type chip cutter machines with a circular rotatable cutter disk on its first axial side being provided with several knives running from the disk centre to its periphery and an opening being provided in the disk in connection with each knife, the opening having a chip guiding surface to guide separated chips to the other axial cutter disk side, the knife comprising a knife carrier, on which the knife is fixed between a first carrier part provided essentially in line with the first axial cutter disk surface and a second carrier part extending downwards in the opening from said cutter disk surface into the cutter disk inside and being a part of the chip guiding device, characterized in that the knife at ist surface opposite to the other carrier part has a chip breaking surface (22) passing the other carrier part in the opening and protects said carrier part from wear in that the separated chips are guided by the chip breaking surface in a direction away from the carrier part.

2. A knife according to claim 1, characterized in that the chip breaking surface (22) is at least in part concave and changes and ends in a rib (24) protruding outwards and downwards from the other carrier part.

3. A knife according to claim 1, characterized in that the chip breaking surface (22) in the first place is plane and thereafter changes into a concave surface ending in a rib (24) protruding outwards and downwards from the other carrier part.

4. A knife according to claim 1 to 3, characterized in that the knife is reversible in that it is symmetric around an axis parallel to the knife edges and situated centrally inbetween these, so that the knife is identically uniform after being reversed half a turn around said axis.

5. A knife according to anyone of claims 1 to 4, characterized in that the knife (12) has two parallel plane contact surfaces (26, 28) in contact with corresponding surfaces on the carrier parts and that the knife edges provide a plane surface (30) essentially coinciding with the cutter disk axial surface and the chip breaking surface (22).

6. A knife according to claim 1, characterized in that the chip breaking surface (22) is achieved, in that the knife (12) is provided with a rib or protrusion (24) passing the carrier part (16) with the knife (12) fixed into the cartridge, so that chips or splinters definitely receive a motion direction leading away from the carrier part 16 and the cutter disk 10.
